(19) United States
(12) Patent Application Publication
(10) Pub. No.: US 2011/0248697 A1
(43) Pub. Date: Oct. 13, 2011

(54) Semiconductor device and data processing system

(75) Inventors: Kazuhiko Kajigaya, Tokyo (JP); Soichiro Yoshida, Tokyo (JP); Yasutoshi Yamada, Tokyo (JP)

(73) Assignee: ELPIDA MEMORY, INC., Tokyo (JP)

(21) Appl. No.: 13/064,683

(22) Filed: Apr. 8, 2011

(30) Foreign Application Priority Data
Apr. 9, 2010 (JP) 2010-090974

(51) Int. Cl. G05F 3/08

(52) U.S. Cl. 323/311

(57) ABSTRACT

A semiconductor device comprises a first circuit outputting a signal to a first signal line, a first FET applied with a driving signal and having a gate electrode connected to a first node, a second FET controlling an electrical connection between the first signal line and the first node, a third FET amplifying a signal of the first node, a second circuit precharging the first signal line, and a voltage control circuit. A gate capacitance of the first FET is controlled in response to a voltage difference between the first node and the driving signal. The voltage control circuit shifts a potential of the driving signal when the second FET is non-conductive after the signal of the first-circuit is transmitted to the first node, and performs an offset control for the driving signal so as to compensate a variation of a threshold voltage of the first FET.

### BACKGROUND OF THE INVENTION

1. Field of the Invention

The present invention relates to a semiconductor device provided with an amplifier that senses and amplifies a signal voltage transmitted through a signal line. For example, the present invention relates to a semiconductor device provided with a single-ended sense amplifier that senses and amplifies data read out from a memory cell through a bit line or provided with a single-ended data amplifier that senses and amplifies the data of the sense amplifier read out thorough a data line.

2. Description of Related Art

In recent years, a decrease in size and an increase in capacity have been achieved in a semiconductor device such as a DRAM, and therefore it is desirable to employ a single-ended circuit configuration with a small circuit scale and a dense arrangement as an amplifier such as a sense amplifier or a data amplifier. For example, an amplifier using a so-called gated amplifier is proposed as a single-ended amplifier capable of effectively amplifying a minute signal (for example, refer to Patent References 1 to 3 and Non-Patent Reference 1). For example, an amplifier suitable for sensing and amplifying the minute signal can be realized, in which a gate electrode of a field-effect transistor (FET) functioning as the gated diode is connected to an input node of the amplifier and a driving voltage of the gated diode is appropriately controlled so as to boost a signal voltage at the input node based on charge transfer between a capacitance of the gated diode and an input capacitance of the amplifier (refer to FIG. 5 of the Non-Patent Reference 1).

[Patent Reference 1] U.S. Pub. No. 2005/0145895 A1
[Patent Reference 2] U.S. Pub. No. 2006/0050581 A1
[Patent Reference 3] U.S. Pub. No. 2009/0103382 A1

### [Non-Patent Reference 1] W. K. Luk, and R. H. Dennard “Gated-Diode Amplifiers,” IEEE Transactions on Circuits and Systems, vol. 52, No. 7, pp. 266-270, May 2005.

In general, threshold voltages of a large number of field-effect transistors (FETs) mounted in a chip fluctuate due to process fluctuation and temperature fluctuation. If the threshold voltage of a field-effect transistor functioning as the above gated diode fluctuates due to manufacturing process or temperature dependence, there arises a problem that sensing margin thereof decreases. Particularly, in a highly integrated memory such as a large capacity DRAM having small manufacturing scales of processes, random variation of the threshold voltage of a FET functioning as the gated diode increases and this variation is added to the fluctuation of the threshold voltage. Therefore, there arises a problem that it is not possible to achieve desired characteristics of the sense amplifier or the data amplifier to which the above conventional configuration is applied.

### SUMMARY

The present invention seeks to solve one or more of the above problems, or to improve upon those problems at least in part.

One of aspects of the invention is a semiconductor device comprising: a first circuit outputting a signal to a first signal line; a first FET in which a gate electrode is connected to a first node and a driving signal is applied to either or both of source and drain electrodes, the first FET having a gate capacitance controlled in response to a voltage difference between potentials of the first node and the driving signal; a second FET controlling an electrical connection between the first signal line and the first node in response to a first control signal applied to a gate electrode; a third FET sensing a signal voltage of the first node and outputting an amplified signal to a second node, the third FET having a gate electrode connected to the first node; a second circuit setting a third potential to the first signal line; and a voltage control circuit transitioning the driving signal from a first potential to a second potential in a state where the second FET is controlled to be non-conductive after the signal of the first circuit is transmitted to the first node via the first line and the second FET being in a conductive state. In the semiconductor device, the voltage control circuit performs an offset control for at least one of the first and third potentials so as to compensate a variation of a threshold voltage of the first FET.

According to the semiconductor device of the invention, the gate capacitance of the first FET as the gated diode is controlled in accordance with the potential of the driving signal, and when the third sense amplifier senses and amplifies a signal voltage transmitted from the first circuit to the first node through the first signal line, the offset control is performed for the first potential of the driving signal in accordance with fluctuation of the threshold voltage of the first FET. By controlling an offset amount of the potential of the driving signal by the voltage control circuit, three voltage relations between the first signal line and the first and second FETs can be kept constant even when the threshold voltage of the first FET fluctuates due to the process and temperature fluctuations. Thereby, it is possible to suppress a decrease in sensing margin in the sensing and amplifying operation in which an amplifying effect of the gate capacitance of the gated diode is applied to the signal voltage transmitted to the first node.

The present invention can be applied to, for example, a configuration including a sense amplifier that senses and amplifies a signal read out from a memory cell to a bit line. Further, the present invention can be applied to, for example, a configuration including a data amplifier that senses and amplifies output transmitted from the sense amplifier to a data line. Further, the present invention can be applied to a data processing system comprising the semiconductor device and a controller connected to the semiconductor device through a bus, in which the controller processes data stored in the semiconductor device and controls operations of the system as a whole and an operation of the semiconductor device.

As described above, according to the present invention, the potential of the driving signal for the gated diode is appropriately controlled corresponding to the fluctuation of the threshold voltage of the gated diode (first FET) connected to the first node as an input node of the amplifier, and thereby it is possible to prevent a decrease in sensing margin due to the fluctuation of the threshold voltage. Particularly, even when random variation of the threshold voltage increases due to a decrease in size and an increase in capacity of a semiconductor device such as a DRAM, the fluctuation caused by manufacturing process or temperature dependence can be reliably compensated and excellent sensing margin can be obtained.

### BRIEF DESCRIPTION OF THE DRAWINGS

The above featured and advantages of the present invention will be more apparent from the following description of certain preferred embodiments taken in conjunction with the accompanying drawings, in which:

FIG. 1 is a block diagram showing a schematic configuration of a DARM of a first embodiment;

FIG. 2 is a diagram showing a circuit configuration of a sense amplifier and its peripheral portion in the first embodiment;

FIG. 3 is a first operation waveform diagram in reading data of a memory cell in the sense amplifier of the first embodiment;

FIG. 4 is a second operation waveform diagram in reading data of the memory cell in the sense amplifier of the first embodiment;

FIG. 5 is a third operation waveform diagram in reading data of the memory cell in the sense amplifier of the first embodiment;

FIG. 6 is a diagram showing a circuit configuration example of a threshold voltage monitor circuit of FIG. 1;

FIG. 7 is a diagram showing a circuit configuration example of a δVt generation circuit of FIG. 1;

FIG. 8 is a diagram showing a circuit configuration example of a VSH generation circuit and a VSL generation circuit of FIG. 1;

FIG. 9 is a diagram showing a circuit configuration example of a driving signal generation circuit of FIG. 1;

FIG. 10 is a first operation waveform diagram in reading data of the memory cell in the sense amplifier of a second embodiment;

FIG. 11 is a second operation waveform diagram in reading data of the memory cell in the sense amplifier of the second embodiment;

FIG. 12 is a diagram showing a circuit configuration example of the δVt generation circuit of the second embodiment;

FIG. 13 is a diagram showing a circuit configuration of the sense amplifier and its peripheral portion in a third embodiment;

FIG. 14 is a first operation waveform diagram in reading data of the memory cell in the sense amplifier of the third embodiment;

FIG. 15 is a second operation waveform diagram in reading data of the memory cell in the sense amplifier of the third embodiment;

FIG. 16 is a third operation waveform diagram in reading data of the memory cell in the sense amplifier of the third embodiment;

FIG. 17 is a first operation waveform diagram in reading data of the memory cell in the sense amplifier of a fourth embodiment;

FIG. 18 is a second operation waveform diagram in reading data of the memory cell in the sense amplifier of the fourth embodiment;

FIG. 19 is a diagram showing a circuit configuration example of the δVt generation circuit of the fourth embodiment; and

FIG. 20 is a diagram showing a configuration example of a data processing system comprising a semiconductor device having the configuration described in the embodiments and a controller controlling operations of the semiconductor device.

### DETAILED DESCRIPTION OF THE PREFERRED EMBODIMENTS

A typical example of a technical idea solving the problems of the present invention will be shown below. However, it goes without saying that the present invention is not limited to the example of the technical idea and should be construed based on the disclosure of the claims.

An example of the technical idea of the invention is applied to an amplifier such as a sense amplifier included in a semiconductor device or a data amplifier amplifying output data of the sense amplifier having a configuration in which when a third FET senses and amplifies a signal voltage at a first node that is sampled by a second FET from a first signal line, a first FET that is connected to a gate electrode of the third FET and has a gate capacitance controlled in response to a driving voltage is operated as a gated diode so that coupling boost thereof occurs corresponding to a first signal voltage associated with data to be sensed. Thereby, fluctuation of the threshold voltage of the first FET is compensated in a sensing operation by offsetting the driving voltage in accordance with the fluctuation of the threshold voltage of the first FET, thereby suppressing a decrease in sensing margin of the sense amplifier or the data amplifier including the third FET as an amplifying element.

Preferred embodiments of the invention will be described in detail below with reference to accompanying drawings. In the following embodiments, the present invention is applied to a DRAM (Dynamic Random Access Memory) as an example of the semiconductor device.

### First Embodiment

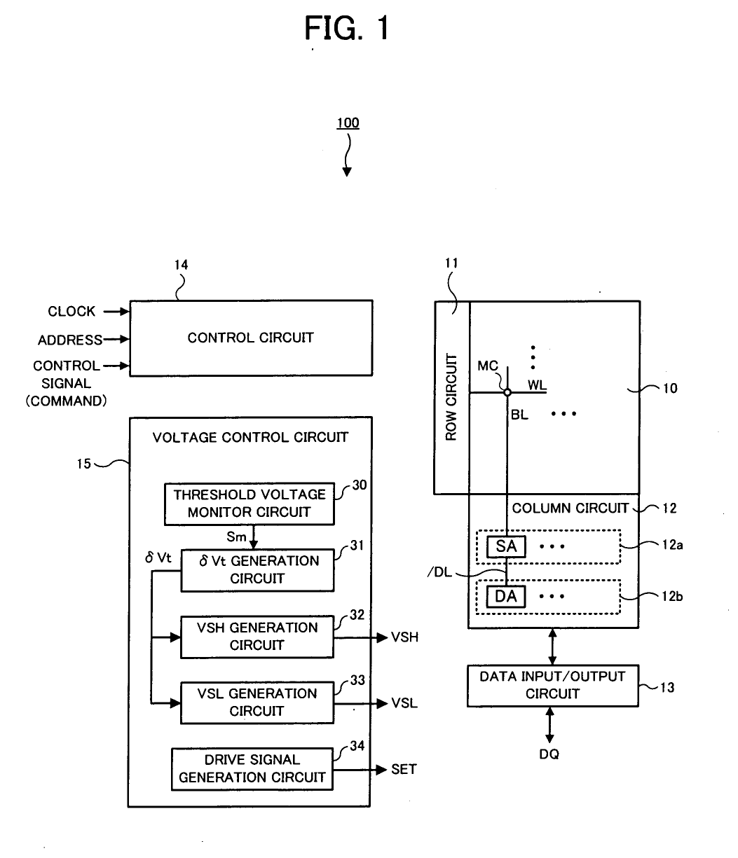

A DRAM of a first embodiment to which the present invention is applied will be described. FIG. 1 is a block diagram showing a schematic configuration of the DARM of the first embodiment, which shows a semiconductor device 100 including a memory cell array region 10, row circuits 11 and column circuits 12 on the periphery of the memory cell array region 10, a data input/output circuit 13, a control circuit 14 and a voltage control circuit 15. In the memory cell array region 10, a plurality of memory cells MC are formed at intersections of a plurality of word lines WL and a plurality of bit lines BL. The row circuits 11 include circuits associated with the word lines WL, and, for example, a plurality of word drivers (not shown) driving the plurality of word lines WL and the like are provide therein. The column circuits 12 includes circuits associated with the bit lines BL, and, for example, a sense amplifier array 12a including a plurality of sense amplifier SA connected to the respective bit lines BL and a data amplifier array 12b including a plurality of data amplifiers DA connected to the respective sense amplifiers SA via a plurality of data lines /DL are provided. The data input/output circuit 13 controls transferring data inputted/outputted from/to the column circuits 12, and inputs/outputs the data via input/output data terminals (DQ).

The control circuit 14 includes various circuits for controlling operations of the entire DRAM in response to external control signals (commands). For example, not only circuits such as a command decoder, but also a clock generator (not shown) generating internal clocks based on an external clock, and an address buffer (not shown) storing an externally input address are included in the control circuit 14. However, these elements are not directly associated with an essence of the present invention, and thus description thereof will be omitted.

The voltage control circuit 15 includes various circuits such as voltage generation circuits generating various voltages supplied to later described circuits in the first embodiment and additional circuits thereto. For example, there are provided a threshold voltage monitor circuit 30 monitoring threshold voltages of FETs (Field Effect Transistors) and outputting a monitor signal Sm, a δVt generation circuit 31 generating later-described δVt that is a variation amount of a later-described threshold voltage based on the monitor signal Sm, a VSH generation circuit 32 and a VSL generation circuit 33 generating voltages VSH and VSL, and a driving signal generation circuit 34 generating a driving signal SET for driving the gated diode, which will be described in detail later. In addition, FIG. 1 shows a part of the configuration of the voltage control circuit 15, and various circuits are provided in the voltage control circuit 15, description of which will be omitted. In the following description, a field effect transistor is simply referred to as “FET” (For example, FET Q1 means field effect transistor Q1).

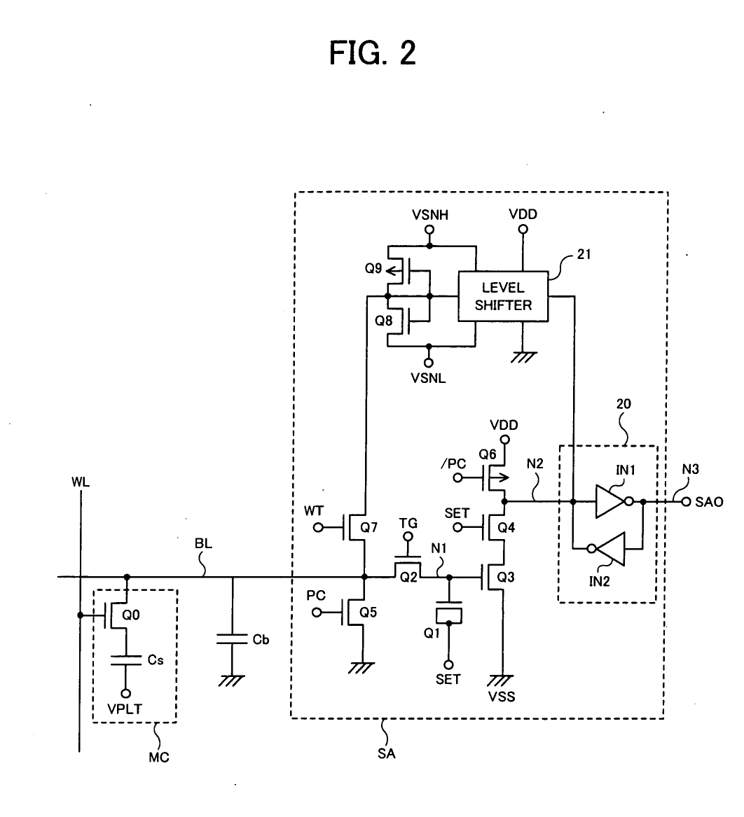

Next, FIG. 2 shows a circuit configuration of the sense amplifier SA and its peripheral portion in the first embodiment. In FIG. 2, a memory cell MC (the first circuit of the invention) arranged at an intersection of one word line WL and one bit line BL (the first signal line of the invention), and a single-ended sense amplifier SA connected to the bit line BL are shown. The memory cell MC is composed of an NMOS type selection transistor Q0 and a capacitor Cs storing data as electric charge. The bit line BL is connected to a source of the selection transistor Q0 and the word line WL is connected to a gate of the selection transistor Q0. The capacitor Cs is connected between a drain of the selection transistor Q0 and a plate voltage VPLT. Further, a bit line capacitance Cb exists at the bit line BL as a parasitic capacitance. The bit line capacitance Cb is determined depending on parasitic capacitances of related lines and the number of connected memory cells MC. Although FIG. 2 shows only one memory cell MC, a plurality of memory cells MC are actually connected to one bit line BL.

The sense amplifier SA is a single-ended sense amplifier including NMOS type FETs Q1, Q2, Q3, Q4, Q5, Q7, Q8, PMOS type FETs Q6, Q9, a latch 20 (the latch circuit), and a level shifter 21. The FET Q1 (the first FET of the invention) has a gate electrode connected to a node N1 (the first node of the invention) and source and drain electrodes to which the driving signal SET is applied, and functions as a gated diode having a gate capacitance that is controlled in response to a voltage difference between the potential of the node N1 and the potential of the driving signal SET. The gate capacitance is a capacitance related to an inversion channel layer of the FET Q1, which is formed mainly in accordance with the voltage difference between the potential of the node N1 and the potential of the driving signal SET. In the following description, the inversion channel layer will be referred to simply as “channel”. In addition, although the driving signal SET is applied to both the source and drain electrodes of the FET Q1 in the example of FIG. 2, the driving signal SET may be applied to either one of the source and drain electrodes of the FET Q1.

In the FET Q1, if the potential of the node N1 is higher than a threshold voltage Vt1 of the FET Q1 based on the potential of the driving signal SET as a reference, the channel is formed so that the gate capacitance increases, and if the potential of the node N1 is lower than the threshold voltage Vt1 of the FET Q1, the channel is not formed so that the gate capacitance decreases. In case of applying the driving signal SET to the FET Q1 (when the first potential is shifted to the second potential), if the potential of the node N1 is higher than the threshold voltage Vt1, the gate capacitance of the FET Q1 increases so that the potential of the node N1 is amplified (large coupling boost value), and on the other hand, if the potential of the node N1 is lower than the threshold voltage Vt1, the gate capacitance of the FET Q1 is so small that the potential of the node N1 is rarely amplified (small coupling boost value). The low level of the driving signal SET is set to a voltage VSL (the first potential of the invention), and the high level thereof is set to a voltage VSH (the second potential of the invention). These voltages VSL and VSH will be described later.

The FET Q2 (the second FET of the invention) controls an electrical connection between the bit line BL and the node N1 in response to a control signal TG applied to its gate. When the control signal TG is changed to “high”, the signal of the bit line BL is sampled at the node N1 via the FET Q2, and thereafter when the control signal TG is changed to “low”, the bit line BL and the node N1 are disconnected from each other so that the bit line capacitance Cb is controlled to be in a state of being invisible from the FET Q1 in the amplifying operation by the driving signal SET.

The FET Q3 (the third FET of the invention) has a gate connected to the node N1, and is switched in accordance with magnitude relation between the potential of the node N1 and a threshold voltage Vt3 of the FET Q3. That is, if the potential of the node N1 is higher than the threshold voltage Vt3, the FET Q3 turns on, and if the potential of the node N1 is lower than the threshold voltage Vt3, the FET Q3 turns off.

The FET Q4 (the fourth FET of the invention) functions as a sensing timing control switch, and the driving signal SET is applied to its gate. When the driving signal SET is driven to “high”, the FET Q4 connects between the FET Q3 and an output side node N2 (the second node of the invention).

The FET Q5 functions as a precharge circuit of the bit line BL, and precharges the bit line BL to a ground potential VSS when a precharge signal PC applied to its gate is “high”. The precharge signal PC is activated when the semiconductor device 100 is in a standby state where no access to memory cells MC is performed. In addition, since the control signal TG is set to “high” during a precharge period, the node N1 is precharged to the ground potential VSS similarly as the bit line BL. Further, the FET Q6 functions as a precharge circuit of the node N2 and precharges the node N2 to a power supply voltage VDD when an inverted precharge signal /PC applied to its gate is “low”.

The latch 20 is composed of a pair of inverters IN1 and IN2 connected in parallel in reverse directions between the node N2 and a node N3, and functions as a level keeper circuit of the sense amplifier SA. An output of the inverter IN1 is outputted from the node N3 (the output terminal of the sense amplifier SA) as a sense amplifier output signal SAO.

The level shifter 21 is a circuit that is connected to the node N2 at an input side and converts an input amplitude of the power supply voltage VDD and the ground potential VSS into an output amplitude of the voltages VSNH and VSNL. A pair of FETs Q8 and Q9 forms an inverter that inverts a signal outputted from the level shifter 21 (The level shifter 21 and the inverter correspond to the second circuit of the invention). An inverted signal outputted from the inverter is applied to a drain of the FET Q7. The FET Q7 functions as a write control switch of the memory cell MC, and has a gate to which a write control signal WT and a source connected to the bit line BL. Therefore, the level shifter 21 and the inverter (the FETs Q8 and Q9) function as a write amplifier directly writing data to the memory cell MC. The write amplifier receives write data supplied from outside of the semiconductor device 100, via the node N3 and the latch circuit 20. Further, the level shifter 21 has a function by which the data of the memory cell MC that is amplified by the sense amplifier SA (including the third and fourth FETs) is restored to the memory cell MC, as described later. When the memory cell MC is a destructive readout type, the write control signal WT is controlled so that output data that is sensed by the FET Q3 and sent to the node N2 is replaced with an inverted potential reverse to the sensed data and is transmitted to the memory cell MC. This is because the configuration of FIG. 2 includes one bit line BL corresponding to the single-ended sense amplifier SA.

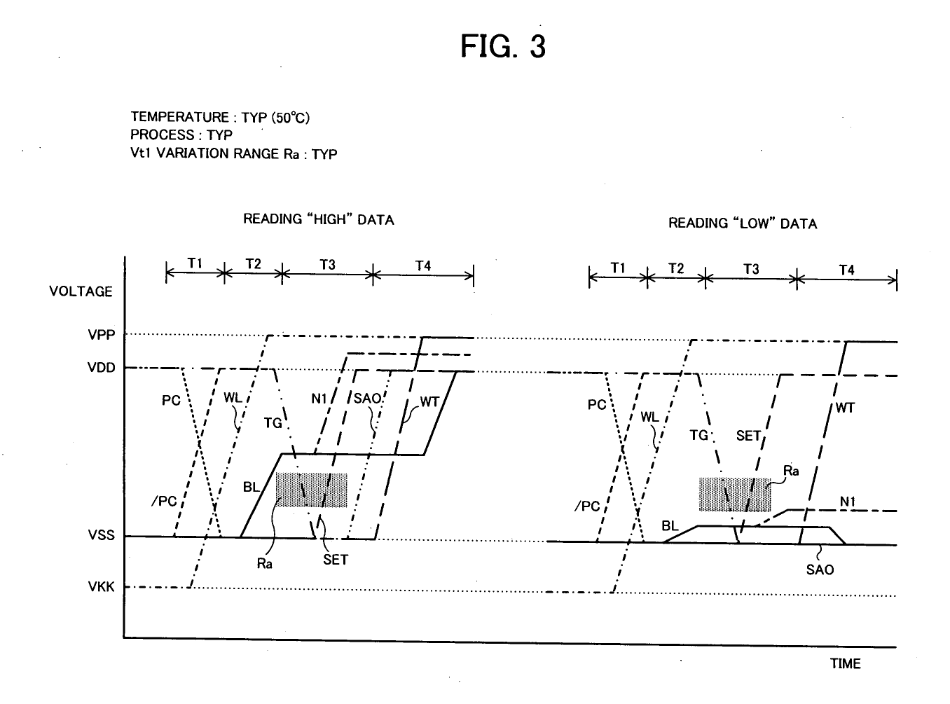

Next, operations in the sense amplifier SA of FIG. 2 when reading out data stored in the memory cell MC will be described with reference to FIGS. 3 to 5. Each of FIGS. 3 to 5 shows a case of reading “high” data (“1”) of the memory cell MC and a case of reading “low” data (“0”) of the memory cell MC, respectively, in the sense amplifier SA. Different three conditions are shown for comparison regarding operating temperature T, manufacturing process, and a variation range Ra of the threshold voltage Vt1 of the FET Q1. In addition, since a large number of sense amplifiers SA exist in the chip, there is random variation of the threshold voltage Vt1 due to random variation in channel impurity density and variation in manufacturing scale even if the respective FETs Q1 are formed in the same process condition. In FIGS. 3 to 5, the variation range Ra of the threshold voltage Vt1 of the FET Q1 is indicated by hatching.

FIG. 3 shows an operation waveform diagram in a case where the operating temperature T is typical (TYP: 50 degrees Celsius, for example), the manufacturing process is typical speed (TYP), and the variation range Ra of the threshold voltage Vt1 is a typical range (TYP). The left side of FIG. 3 corresponds to a read operation of “high” data of the memory cell MC, in which one electrode (node between the selection transistor Q0 and the capacitor Cs) of the capacitor Cs of the memory cell MC is at the voltage VSNH corresponding to the “high” data in an initial period. Before a precharge cancellation period T1, the precharge signal PC is set to “high” (the inverted precharge signal PC is set to “low”), the bit line BL and the node N1 are precharged to the ground potential VSS, the node N2 (FIG. 2) is precharged to the power supply voltage VDD, and the node N3 (the sense amplifier output signal SAO) is maintained at the ground potential VSS. When the precharge cancellation period T1 is started, the precharge signal PC is changed to “low” (the inverted precharge signal PC is changed to “high”), and both the bit line BL and the node N1 are maintained at the ground potential VSS so as to be into a floating state, and the node N2 is in a state of being maintained at the power supply voltage VDD by the latch 20. At this point, the node N3 continues to be at the ground potential VSS by the latch 20.

Then, during a memory cell selection period T2, the word line WL is driven to a boost voltage VPP from a negative voltage VKK so that the selection transistor Q0 turns on, and a signal voltage corresponding to the “high” data of the memory cell MC is read out to the bit line BL. At this point, since the control signal TG is at a high level, the signal voltage read out to the bit line BL is transmitted to the node N1 via the FET Q2. Subsequently, during a sensing period T3, the control signal TG is changed to “low”, and after the bit line BL and the node N1 are disconnected from each other, the potential of the driving signal SET is driven to the power supply voltage VDD from the ground potential VSS. At this point, as shown in FIG. 3 where the random variation range Ra of the threshold voltage Vt1 is overlapped with the operation waveform diagram, the potential of the node N1 is higher than the upper limit of the variation range Ra. Therefore, a channel is formed in the FET Q1 so that the gate capacitance increases, and the potential of the node N1 is largely increased by the coupling boost. As a result, since the potential of the node N1 becomes higher than the threshold voltage Vt3 of the FET Q3 so that the FET Q3 turns on, the potential of the node N2 rapidly decreases to the ground potential VSS and the potential of the node N3 rises to the power supply voltage VDD, thereby reading out the sense amplifier output signal SAO of the “high” data. In addition, the bit line BL continues to be at the same potential since it is disconnected from the node N1 by the FET Q2.

Subsequently, during a restoration period T4, the write control signal WT is changed to the boost voltage VPP, the potential of the node N2 is inverted to the voltage VSNH by the level shifter 21 and the FETs Q8 and Q9, the bit line BL is driven to the voltage VSNH via the FET Q7, and the “high” data is restored to the memory cell MC. In addition, in the example of FIG. 3, the voltage VSNH is set to be equal to the power supply voltage VDD.

Next, the right side of FIG. 3 corresponds to a read operation of “low” data of the memory cell MC, in which one electrode of the capacitor Cs of the memory cell MC is at the voltage VSNL corresponding to the “low” data in an initial period. Operation waveforms before and during the precharge cancellation period T1 are the same as those in the left side of FIG. 3, so description thereof will be omitted. Meanwhile, during the memory cell selection period T2, the word line WL is driven to the boost voltage VPP from the negative voltage VKK so that the selection transistor Q0 turns on, and a signal voltage corresponding to the “low” data is read out to the bit line BL. Subsequently, during the sensing period T3, the control signal TG is changed to “low” so that the bit line BL and the node N1 are disconnected from each other, and thereafter the driving signal SET is driven to the power supply voltage VDD. At this point, since the potential of the node N1 is lower than the lower limit of the variation range Ra of the threshold voltage Vt1, no channel is formed in the FET Q1 so that the potential of the node N1 slightly rises. The slight rise thereof is due to a physical parasitic capacitance between the source electrode and the gate electrode. As a result, since the potential of the node N1 is lower than the threshold voltage Vt3 of the FET Q3 so that the FET Q3 remains in an off state, the potential of the node N2 is maintained at the power supply voltage VDD, the potential of the node N3 is maintained at the ground potential VSS, and the sense amplifier output signal SAO of the “low” data is read out. In addition, the bit line BL continues to be at the same potential since it is disconnected from the node N1 by the FET Q2. One of features of the invention is that no channel is formed in the FET Q1 when reading data “0” due to the first and second potentials that have offset amounts controlled by the voltage control circuit 15.

Subsequently, during the restoration period T4, the write control signal WT is changed to the boost voltage VPP, the potential of the node N2 is inverted to the voltage VSNL by the level shifter 21 and the FETs Q8 and Q9, the bit line BL is driven to the voltage VSNL via the FET Q7, and the “low” data is restored to the memory cell MC. In addition, in the example of FIG. 3, the voltage VSNL is set to be equal to the ground potential VSS.

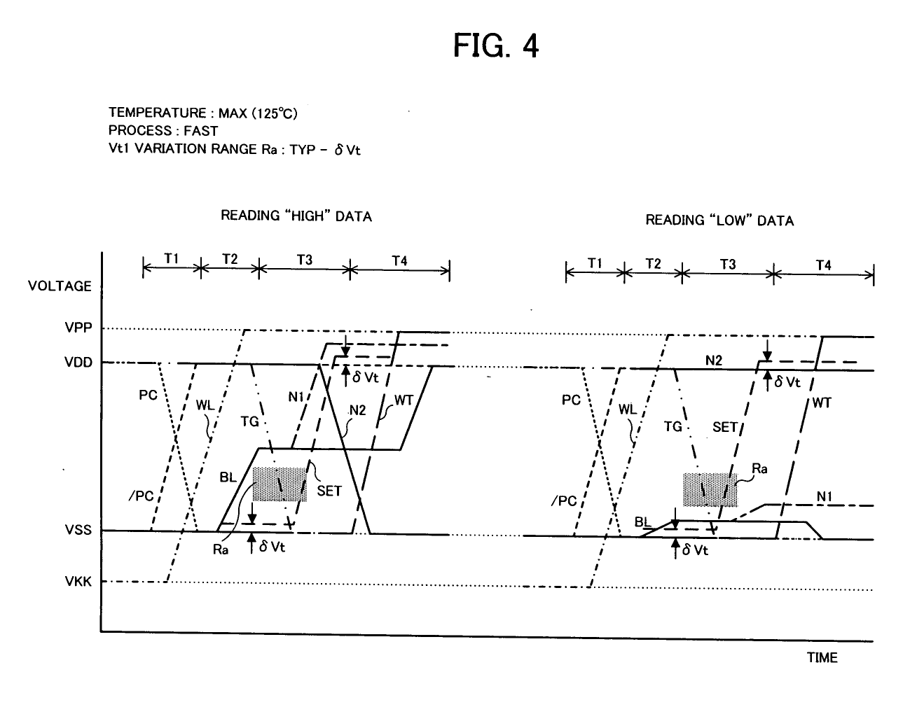

Next, FIG. 4 shows an operation waveform diagram in a case where the operating temperature T is maximum (MAX: 125 degrees Celsius, for example), the manufacturing process is fast speed (FAST), and the variation range Ra of the threshold voltage Vt1 is shifted downward from the typical. Specifically, the variation range Ra of FIG. 4 is shifted to a condition (TYP−δVt) lower than the condition (TYP) of FIG. 3 by δVt. For such a condition, in the first embodiment, the offset control of the potential of the driving signal SET is performed in conjunction with the variation range Ra, as described later.

Operation waveforms of FIG. 4 are different from those of FIG. 3 in that the low level of the driving signal SET is controlled to be a potential VSS+δV that is offset upward from the ground potential VSS of FIG. 3 by δVt, and that the high level of the driving signal SET is controlled to be a potential VDD+δV that is offset upward from the power supply voltage VDD of FIG. 3 by δVt. Accordingly, when the signal voltage is read out to the bit line BL during the respective sensing periods T3 of the left and right sides of FIG. 4, a relative position relation of the variation range Ra relative to the potential of the driving signal SET is the same condition as in FIG. 3. As a result, the shifting of the variation range Ra of the threshold voltage Vt1 due to temperature fluctuation and process fluctuation can be compensated.

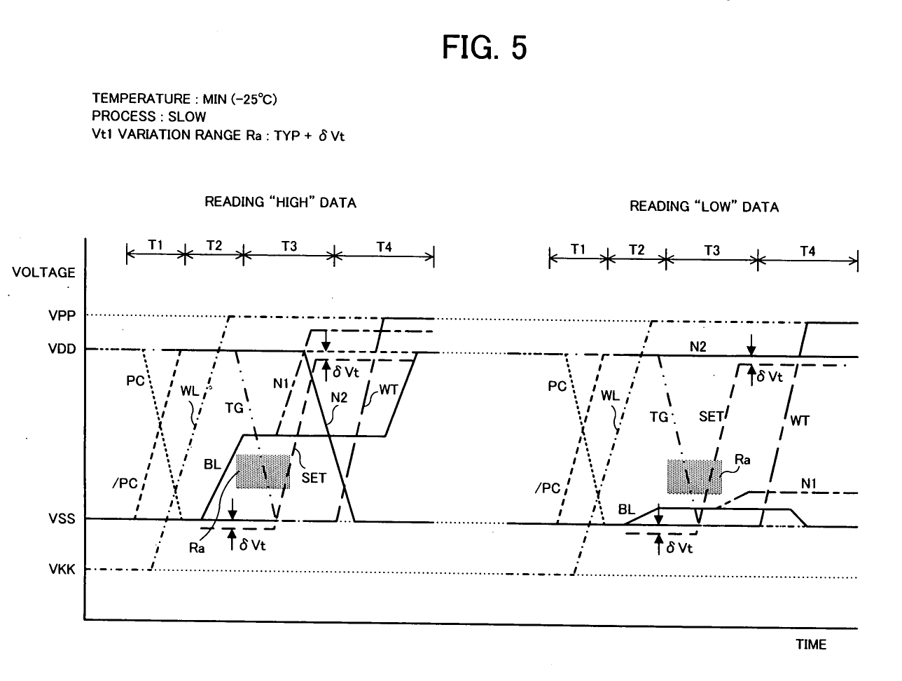

Next FIG. 5 shows an operation waveform diagram in a case where the operating temperature T is minimum (MIN: −25 degrees Celsius, for example), the manufacturing process is slow speed (SLOW), and the variation range Ra of the threshold voltage Vt1 is shifted upward from the typical. Specifically, the variation range Ra of FIG. 5 is shifted to a condition (TYP+δVt) higher than the condition of FIG. 3 (TYP) by δVt. For such a condition, in the first embodiment, the offset control of the potential of the driving signal SET is performed in conjunction with the variation range Ra similarly as in FIG. 4.

Operation waveforms of FIG. 5 are different from those of FIG. 3 in that the low level of the driving signal SET is controlled to be a potential VSS−δV that is offset downward from the ground potential VSS of FIG. 3 by δVt, and that the high level of the driving signal SET is controlled to be a potential VDD−δV that is offset downward from the power supply voltage VDD of FIG. 3 by δVt. Accordingly, when the signal voltage is read out to the bit line BL during the respective sensing periods T3 of the left and right sides of FIG. 5, a relative position relation of the variation range Ra relative to the potential of the driving signal SET is the same condition as in FIGS. 3 and 4. As a result, the shifting of the variation range Ra of the threshold voltage Vt1 due to the temperature and process fluctuations can be compensated.

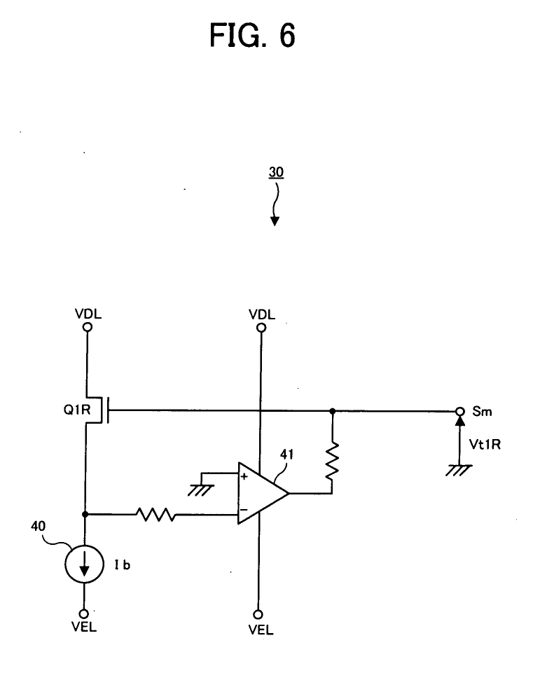

FIG. 6 shows a circuit configuration example of the threshold voltage monitor circuit 30 of FIG. 1. As shown in FIG. 6, the threshold voltage monitor circuit 30 includes a replica FET Q1R, a constant current source 40 and an operational amplifier 41, and is supplied with a positive voltage VDL and a negative voltage VEL as positive/negative constant voltage supplies. The replica FET Q1R functions as a replica element of the FET Q1 to be monitored, and is formed approximately in the same shape and size as the FET Q1. The constant current source 40 in which a constant current Ib flows is connected between the replica FET Q1R and the negative voltage VEL. The operational amplifier 41 receives a source voltage of the replica FET Q1r at a minus-side input terminal via a resistor, and receives the ground potential VSS at a plus-side input terminal. An output terminal of the operational amplifier 41 is connected to the gate of the replica FET Q1r via a resistor. Thereby, feedback control is performed so that the source voltage of the replica FET Q1r matches the ground potential VSS in a state where the constant current Ib flows. Accordingly, the monitor signal Sm outputted from the monitor circuit 30 matches a threshold voltage Vt1R of the replica FET Q1r with reference to the ground potential VSS.

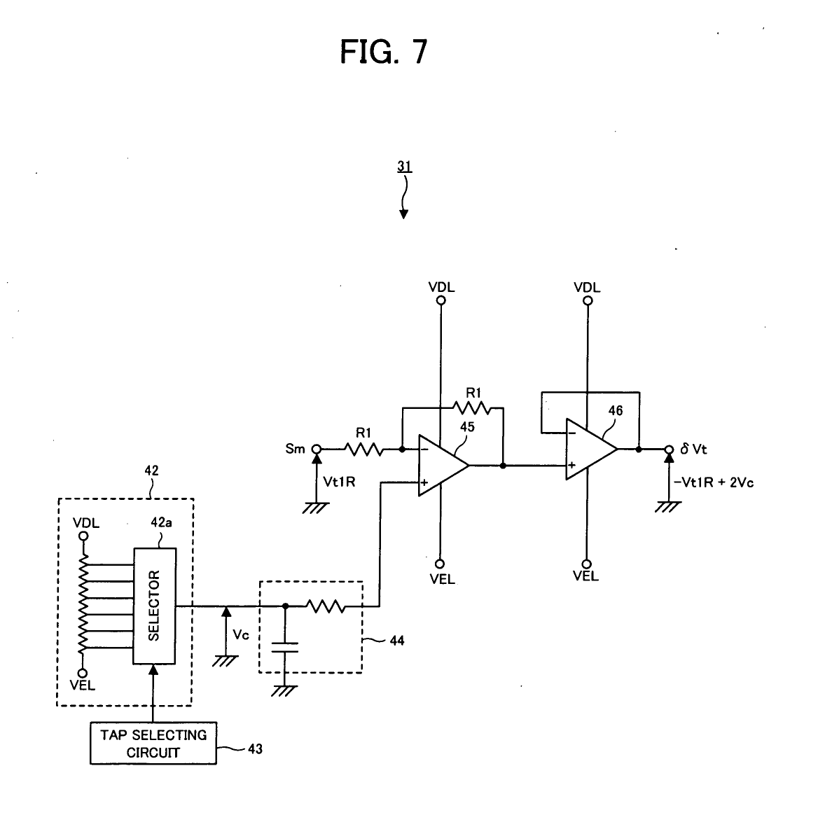

FIG. 7 shows a circuit configuration example of the δVt generation circuit 31 of FIG. 1. As shown in FIG. 7, the δVt generation circuit 31 includes a correction amount setting circuit 42, a tap selecting circuit 43, a low-pass filter 44 and two operational amplifiers 45 and 46. The correction amount setting circuit 42 sets a desired voltage selected by a selector 42a from a large number of intermediate voltages between the positive voltage VDL and the negative voltage VEL using resistive division, and outputs the voltage as a correction amount Vc. Selection in the selector 42a is carried out based on an output signal of the tap selecting circuit 43 in which information of selectable intermediate voltages is programmed. In the correction amount setting circuit 42, the correction amount Vc is set so that, for example, δVt=0V is satisfied when the manufacturing process is “TYP” and the temperature is 50 degrees Celsius. The correction amount Vc set in this manner is reflected in the value of δVt so that the fluctuation of the threshold voltage Vt1 due to the fluctuation of manufacturing process at the temperature of 50 degrees Celsius is compensated. In order to program the correction amount Vc in the tap selecting circuit 43, it is possible to utilize laser fuses, electrical fuses, a nonvolatile memory element, a one-time programmable element or the like.

The first operational amplifier 45 functions as inverting amplification circuit/level shifting circuit having a gain of 1, receives the monitor signal Sm (voltage Vt1R) outputted from the threshold voltage monitor circuit 30 (FIG. 6) at a minus-side input terminal, and receives the correction amount Vc smoothed through the low-pass filter 44 composed of a resistor and a capacitor as a shifted voltage at a plus-side input terminal. The operational amplifier 45 outputs a voltage −Vt1R+2Vc. The second operational amplifier 46 is a voltage follower functioning as a driver circuit and outputs an output voltage −Vt1R+2Vc that matches the output voltage of the operational amplifier 45 as the voltage δVt.

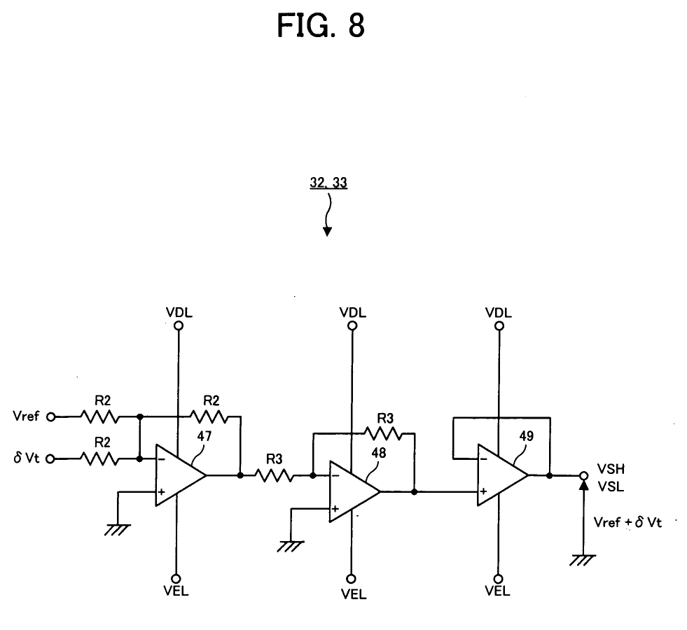

FIG. 8 shows a circuit configuration example of the VSH generation circuit 32 and the VSL generation circuit 33 of FIG. 1. Although circuit configurations of the VSH generation circuit 32 and the VSL generation circuit 33 are common to each other, voltage values thereof are set differently from each other, as described later. As shown in FIG. 8, the VSH (VSL) generation circuit 32 (33) includes three operational amplifiers 47, 48 and 49. The first operational amplifier 47 adds the reference voltage Vref and the voltage δVt from the δVt generation circuit 31 and inverts the added signal. The second operational amplifier 48 further inverts the output of the operational amplifier 47. The third operational amplifier 49 is a voltage follower that strengthens a current driving ability of the operational amplifier 48 and outputs the voltage 0Vref+δVt. The value of the reference voltage Vref is set to, for example, 1V for the VSH generation circuit 32 and 0V for the VSL generation circuit 33, respectively. The value of the voltage δVt is, for example, ±0.1V for both the VSH generation circuit 32 and the VSL generation circuit 33. In this case, in the VSH generation circuit 32 and the VSL generation circuit 33, VSH=1±0.1V and VSL=0±0.1V are satisfied and these are supplied to the driving signal generation circuit 34, as described later.

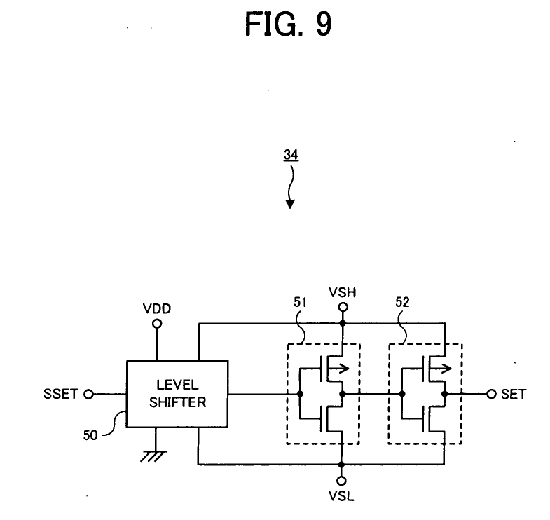

FIG. 9 shows a circuit configuration of the driving signal generation circuit 34 of FIG. 1. As shown in FIG. 9, the driving signal generation circuit 34 includes a level shifter 50 and two-stage inverters 51 and 52. The level shifter 50 receives a control signal SSET having the input amplitude of the power supply voltage VDD and the ground potential VSS, and converts it into the output amplitude of the voltages VSH and VSL. The two-stage inverters 51 and 52 function as a driver, an output signal of the level shifter 50 is inputted to the first inverter 51, and the driving signal SET is outputted from the second inverter 52.

As described above, in the sense amplifier SA of the first embodiment, when the variation range Ra of the threshold voltage Vt1 of the FET Q1 as the gated diode whose gate electrode is connected to the node N1 fluctuates by δVt, control is performed so that the low level of the driving voltage VSET for the FET Q1 is offset from the ground potential VSS by −δVt and the high level thereof is offset from the power supply voltage VDD by −δVt. Thus, the voltage relation between the FETs Q1 and Q3 relative to the signal voltage of the bit line BL is kept the same, the fluctuation of the threshold voltage Vt1 due to the process and temperature fluctuations is compensated, and it is possible to prevent a decrease in sensing margin in the sense amplifier SA. Additionally, in the description of the first embodiment, the offset control is performed for both low and high levels of the driving signal SET applied to the FET Q1 so as to maintain the amplitude of the driving signal SET before the offset control. However, the offset control may be performed only for the low level of the driving signal SET, and in this case, the fluctuation of the threshold voltage Vt1 can be compensated. The above described effects are common in a later described second embodiment.

### Second Embodiment

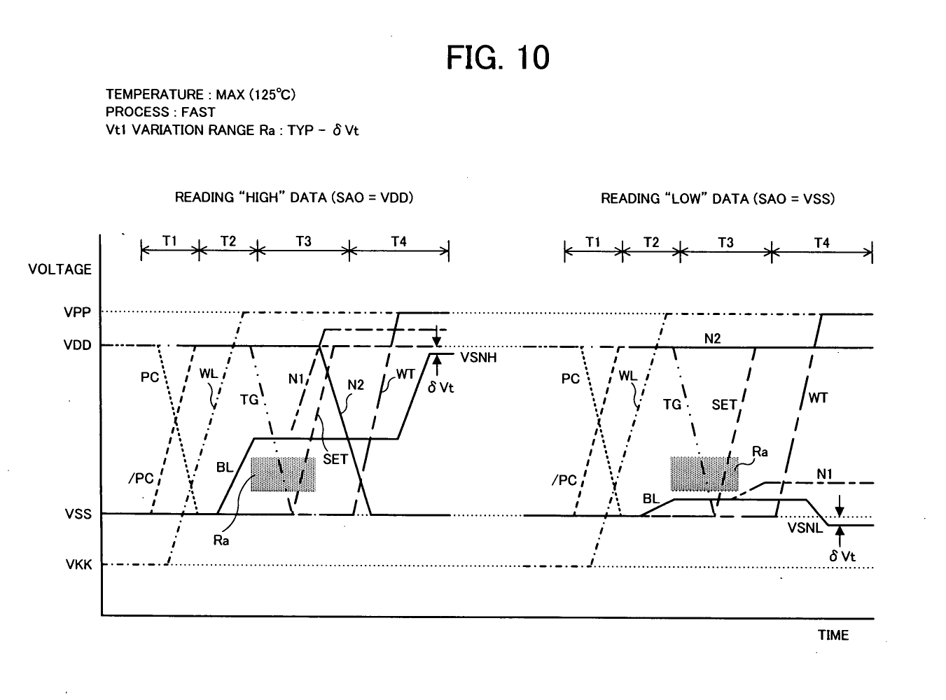

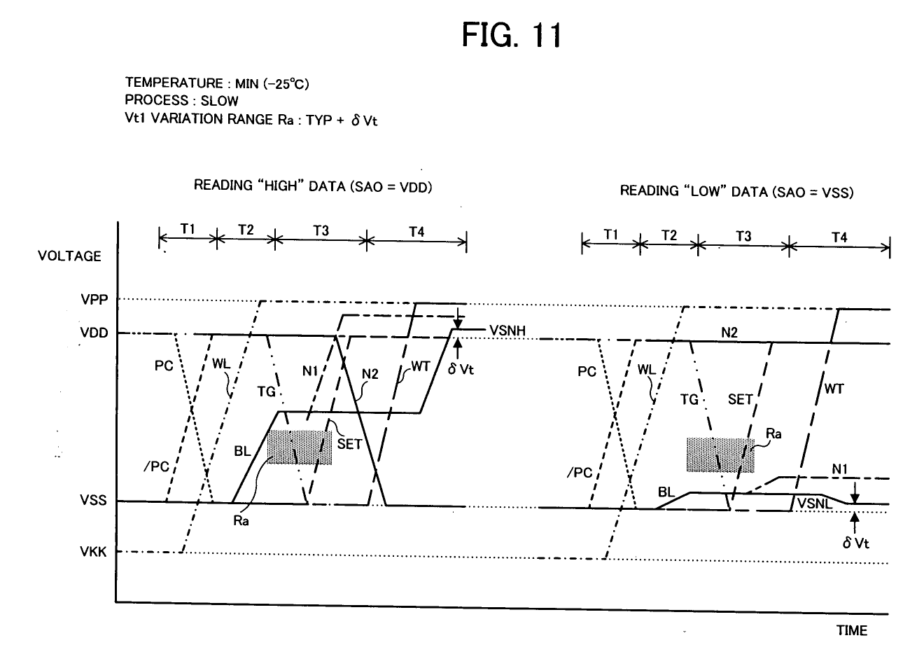

A DRAM of a second embodiment to which the present invention is applied will be described. Although voltage control conditions in the second embodiment are different from those in the first embodiment, the entire configuration of the DRAM of FIG. 1 and the circuit configuration of the sense amplifier SA and its peripheral portion of FIG. 2 are the same as in the first embodiment and thus description thereof will be omitted. In the following, an operation in which data stored in the memory cell MC is read out in the sense amplifier SA of the second embodiment will be described with reference to FIGS. 10 and 11.

Next, FIG. 10 shows an operation waveform diagram in a case where the operating temperature T is maximum (MAX: 125 degrees Celsius, for example), the manufacturing process is fast speed (FAST), and the variation range Ra of the threshold voltage Vt1 is shifted downward from the typical, similarly as in FIG. 4. Although the offset control in the first embodiment is performed for the low and high levels of the driving signal SET (FIG. 4), a feature of the second embodiment is that the offset control is performed for the voltages VSNH, VSNL and the plate voltage VPLT with a predetermined amount, instead of the driving signal SET. Specifically, the voltages VSNH, VSNL and the plate voltage VPLT are offset to values lower by TR·δVt for the voltage δVt. Here, TR is represented as TR=(Cs+Cb)/Cs using the bit line capacitance Cb and the capacitor Cs (its capacitance Cs). This relation allows the signal voltage read out to the bit line BL to be shifted by −δVt as shown in FIG. 10. As a result, it is possible to compensate the shifting of the variation range Ra of the threshold voltage Vt1 due to the temperature and process fluctuations. Additionally, in the second embodiment, the offset control may be performed for at least the voltages VSNH and VSNL. In the best mode of the second embodiment, the offset control is also performed for the plate voltage VPLT in addition to the voltages VSNH and VSNL, and this is because reliability of a dielectric film needs to be obtained by keeping the voltage applied to the capacitor Cs constant.

FIG. 11 shows an operation waveform diagram in a case where the operating temperature T is minimum (MIN: −25 degrees Celsius, for example), the manufacturing process is slow speed (SLOW), and the variation range Ra of the threshold voltage Vt1 is shifted upward from the typical, similarly as in FIG. 5. The voltages VSNH, VSNL and the plate voltage VPLT are offset to values higher by TR·δVt, respectively, instead of offsetting the driving signal SET to a value higher by δVt (FIG. 5) , similarly as in FIG. 10. As described above, TR is represented as TR=(Cs+Cb)/Cs. In this case, the signal voltage read out to the bit line BL is shifted by +δVt. As a result, it is possible to compensate the shifting of the variation range Ra of the threshold voltage Vt1 due to the temperature and process fluctuations.

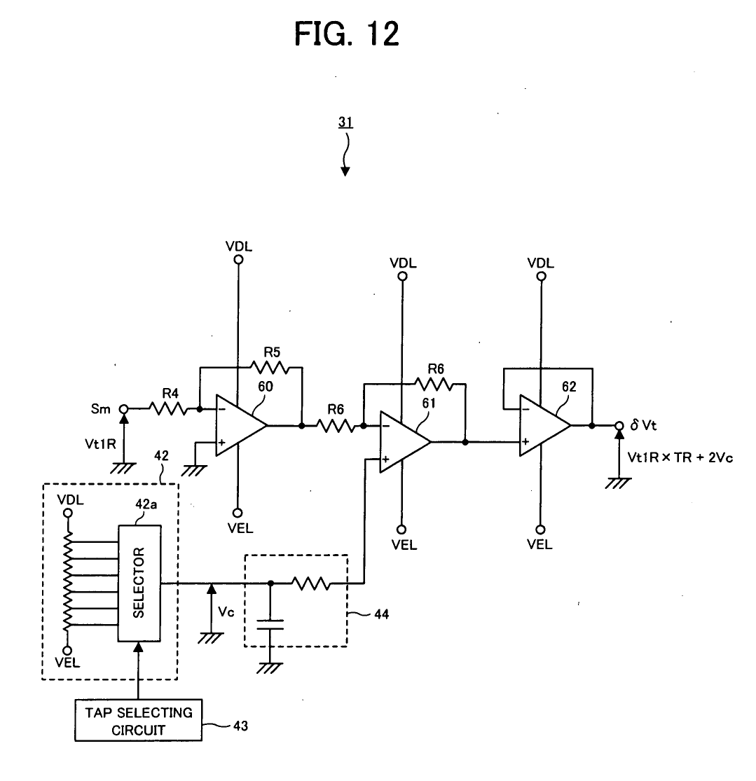

FIG. 12 shows a circuit configuration example of the δVt generation circuit 31 of the second embodiment. Here, the threshold voltage monitor circuit 30 (FIG. 6) of the first embodiment is common in the second embodiment. In the δVt generation circuit 31 of FIG. 12, the correction amount setting circuit 42, the tap selecting circuit 43, the low-pass filter 44 are the same as those in FIG. 7 of the first embodiment, so description thereof will be omitted. In the δVt generation circuit 31 of FIG. 12, a partial configuration of three operational amplifiers 60, 61 and 62 is different from FIG. 7. The first operational amplifier 60 functions as an inverting amplification circuit having a gain of TR, receives the voltage Vt1R outputted from the threshold voltage monitor circuit 30 (FIG. 6) as a shifted voltage at a minus-side input terminal, and receives the ground potential VSS at a plus-side input terminal. Since resistance ratio of the operational amplifier 60 is set to R4/R5=Cs/(Cs+Cb)=TR, an output voltage thereof becomes −Vt1R×TR.

The second operational amplifier 61 functions as inverting amplification circuit/level shifting circuit having a gain of −1, receives the output signal of the operational amplifier 60 at a minus-side input terminal, and receives the above correction amount Vc as a shifted voltage at a plus-side input terminal. The operational amplifier 61 outputs a voltage −Vt1R×TR+2Vc. The third operational amplifier 62 is a voltage follower functioning as a driver circuit and outputs an output voltage −Vt1R·TR+2Vc that matches the output voltage of the operational amplifier 61 as the voltage δVt.

In the second embodiment, the circuit configuration as in FIG. 8 of the first embodiment is applied to a VSNH generation circuit, a VSNL generation circuit and a VPLT generation circuit respectively. However, the reference voltage Vref in these circuits is set differently from the first embodiment. That is, the value of the reference voltage Vref is set to, for example, Vref=1V for the VSNH generation circuit, Vref=0V for the VSNL generation circuit, and Vref=0.5V for the VPLT generation circuit, respectively. The value of the voltage δVt becomes, for example, δVt=±0.1V for the VSNH generation circuit, the VSNL generation circuit and the VPLT generation circuit, respectively. In these cases, VSNH=1±0.1V, VSNL=0±0.1V and VPLT=0.5±0.1V are satisfied respectively.

### Third Embodiment

A DRAM of a third embodiment to which the present invention is applied will be described. Although the first and second embodiments have described that the invention is applied to the sense amplifier SA of the DRAM, the third embodiment will describe that the invention is applied to a data amplifier DA of the DRAM. The DRAM of the third embodiment has the same entire configuration as that in FIG. 1 of the first embodiment and thus description thereof will be omitted. In the third embodiment, portions different from the first embodiment will be mainly described.

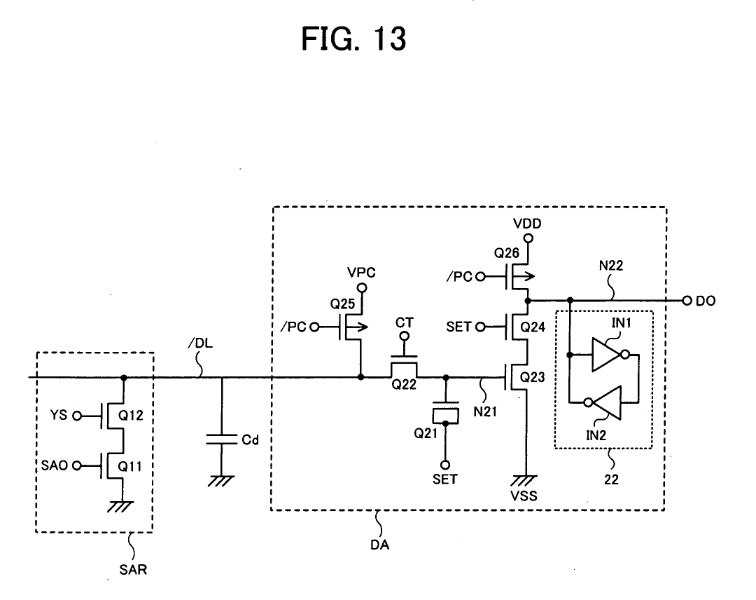

FIG. 13 shows a circuit configuration of the data amplifier DA and its peripheral portion in the third embodiment. In FIG. 13, a read circuit portion SAR (the first circuit of the invention) of the sense amplifier SA, and a single-ended data amplifier DA connected to the read circuit portion SAR via a data line /DL (the first signal line of the invention). The read circuit portion SAR of the sense amplifier SA is composed of two NMOS type FETs Q11 and Q12 connected in series between the data line /DL and the ground potential VSS. The above sense amplifier output signal SAO is applied to the gate of the FET Q11, and a sense amplifier selection signal YS is applied to the gate of the FET Q12. A data line capacitance Cd exists at the data line /DL. The data line capacitance Cd is determined depending on parasitic capacitances of lines and the number of connected sense amplifiers SA. Although FIG. 13 shows only one read circuit portion SAR, actually one data line /DL is shared by a plurality of sense amplifiers SA, and therefore a plurality of read circuit portions SAR are connected to the data line /DL.

The read circuit portion SAR may include the configuration of the first embodiment. Specifically, the sense amplifier SA corresponds to either one of the first, second and later-described forth embodiments, while the data amplifier DA corresponds to the third embodiment.

The data amplifier DA is a single-ended data amplifier including NMOS type FETs Q21, Q22, Q23 and Q24, PMOS type FETs Q25, Q26, and a latch 22. The FET Q21 (the first FET of the invention) functions as a gated diode, and has a gate electrode connected to a node N21 (the first node of the invention) and source and drain electrodes to which the driving signal SET is applied. The driving signal SET is the same as the driving signal SET of FIG. 2, and the FET Q21 corresponds to the FET Q1 of FIG. 2. Behavior of the FET Q21 driven by the driving signal SET and sensing and amplifying of the signal voltage at the node N21 are the same as those described in the first embodiment.

The FET Q22 (the second FET of the invention) controls an electrical connection between the data line /DL and a node N21 in response to the control signal CT applied to its gate. When the control signal CT is changed to “high”, a signal of the data line /DL is sampled at the node N21 via the FET Q22, and thereafter when the control signal CT is changed to “low”, the data line /DL and the node N21 are disconnected from each other so that the data line capacitance Cd is controlled to be in a state of being invisible from the FET Q21 in the operation using the driving signal SET.

The FET Q23 (the third FET of the invention) has a gate connected to the node N21, and is switched in accordance with magnitude relation between the potential of the node N21 and a threshold voltage Vt23 of the FET Q23. That is, if the potential of the node N21 is higher than the threshold voltage Vt23, the FET Q23 turns on, and if the potential of the node N21 is lower than the threshold voltage Vt23, the FET Q23 turns off. Further, the FET Q24 (the fourth FET of the invention) functions as a sensing timing control switch, and the driving signal SET is applied to its gate. When the driving signal SET is driven to “high”, the FET Q24 connects between the FET Q23 and an output side node N22 (the second node of the invention).

The FET Q25 functions as a precharge circuit (the second circuit of the invention) of the data line /DL, and precharges the data line /DL to a precharge voltage VPC when the inverted precharge signal /PC applied to its gate is “low”. In addition, since the control signal CT is set to “high” during the precharge period, the node N21 is also precharged to the precharge voltage VPC similarly as the data line /DL. Since the precharge voltage VPC can be set lower than the power supply voltage VDD in the data amplifier DA, it is possible to reduce consumption current in a high-speed simultaneous read operation for a large number of data lines /DL.

Meanwhile, the FET Q26 functions as a precharge circuit of the node N22 and precharges the node N22 to the power supply voltage VDD when the inverted precharge signal /PC applied to its gate is “low”. Further, the latch 22 is connected to the node N22 and functions as a level keeper circuit having the same configuration as the latch 20 of FIG. 2. A signal of the node N22 is outputted as the data amplifier output signal DO.

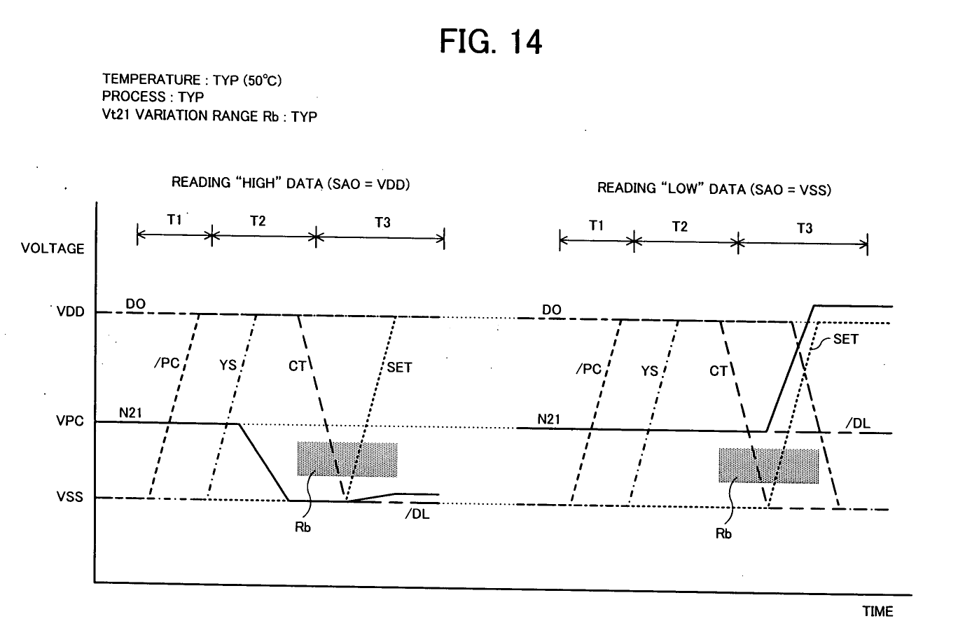

Next, operations in the data amplifier DA of FIG. 13 when reading out data stored in the memory cell MC will be described with reference to FIGS. 14 to 16. Each of FIGS. 14 to 16 shows a case of reading “high” data at the data line /DL read out in the data amplifier DA and a case of reading “low” data at the data line /DL read out in the data amplifier DA. Meanings of conditions of the operating temperature T, the manufacturing process, and a variation range Rb of a threshold voltage Vt21 of the FET Q21 are common to those in FIGS. 3 to 5 of the first embodiment. In FIGS. 14 to 16, the variation range Rb of the threshold voltage Vt21 of the FET Q21 is indicated by hatching, the meaning of which is also common to that of the variation range Ra in the first embodiment.

FIG. 14 shows an operation waveform diagram in a case where the operating temperature T is typical (TYP: 50 degrees Celsius, for example), the manufacturing process is typical speed (TYP), and the variation range Rb of the threshold voltage Vt21 is a typical range (TYP). The left side of FIG. 14 corresponds to a read operation of “high” data from the sense amplifier SA, in which the sense amplifier output signal SAO (FIG. 13) is at the power supply voltage VDD in an initial period. Before the precharge cancellation period T1, the inverted precharge signal /PC is set to “low”, the data line /DL and the node N21 are both precharged to the precharge voltage VPC, and the node N22 (FIG. 13) is precharged to the power supply voltage VDD. When the precharge cancellation period T1 is started, the inverted precharge signal /PC is changed to “high”, the data line /DL and the node N21 are both maintained at the precharge voltage VPC so as to be into a floating state, and the data amplifier output signal DO is maintained at the power supply voltage VDD by the latch 22.

Then, during a sense amplifier selection period T2, the sense amplifier selection signal YS is changed to “high”, and the data line /DL is driven to the ground potential VSS by the sense amplifier output signal SAO maintained at the power supply voltage VDD. At this point, since the control signal CT is at a high level, the ground potential VSS at the data line /DL is transmitted to the node N21 via the FET Q22. Subsequently, during an amplification period T3, the control signal CT is changed to “low”, and after the data line /DL and the node N21 are disconnected from each other, the potential of the driving signal SET is driven to the power supply voltage VDD from the ground potential VSS. At this point, as shown in FIG. 14 where the random variation range Rb of the threshold voltage Vt21 is overlapped with the operation waveform diagram, the potential of the node N21 is lower than the lower limit of the variation range Rb. Therefore, no channel is formed in the FET Q21 so that the potential of the node N21 slightly rises. As a result, since the potential of the node N21 becomes lower than the threshold voltage Vt23 of the FET Q23 and the FET Q23 remains in an off state, the potential of the node N22 is maintained at the power supply voltage VDD, thereby reading out the data amplifier output signal DO of the “high” data. In addition, the data line /DL continues to be at the ground potential VSS since it is disconnected from the node N21 by the FET Q22.

Next, the right side of FIG. 14 corresponds to a read operation of “low” data from the sense amplifier SA, in which the sense amplifier output signal SAO (FIG. 13) is at the ground potential VSS in an initial period. Operation waveforms before and during the precharge cancellation period T1 are the same as those in the left side of FIG. 14, so description thereof will be omitted. Meanwhile, during the sense amplifier selection period T2, when the sense amplifier selection signal YS is changed to “high”, the data line /DL and the node N21 continue to be at the precharge voltage VPC since the sense amplifier output signal SAO is maintained at the ground potential VSS. Subsequently, during the amplification period T3, the control signal CT is changed to “low” so that the data line /DL and the node N21 are disconnected from each other, and thereafter the driving signal SET is driven to the power supply voltage VDD. At this point, the potential of the node N21 is at the precharge voltage VPC and thus is higher than the upper limit of the variation range Rb of the FET Q21. Therefore, a channel is formed in the FET Q21 so that the gate capacitance increases, and the potential of the node N21 is largely increased. As a result, since the potential of the node N21 is higher than the threshold voltage Vt23 of the FET Q23 so that the FET Q23 turns on, the potential of the node N22 is decreased to the ground potential VSS, and the data amplifier output signal DO of the “low” data is read out. In addition, the data line /DL continues to be at the precharge voltage VPC since it is disconnected from the node N21 by the FET Q22.

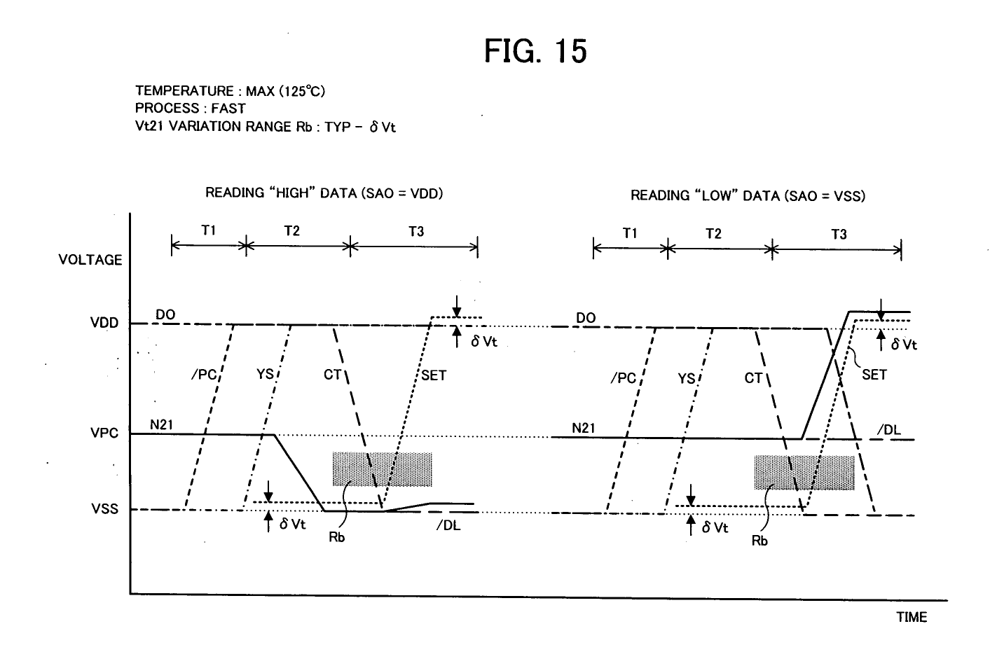

Next, FIG. 15 shows an operation waveform diagram in a case where the operating temperature T is maximum (MAX: 125 degrees Celsius, for example), the manufacturing process is fast speed (FAST), and the variation range Rb of the threshold voltage Vt21 is shifted downward from the typical. Specifically, the variation range Rb of FIG. 15 is shifted to a condition (TYP−δVt) lower than the condition (TYP) of FIG. 14 by δVt. For such a condition, in the third embodiment, the offset control of the potential of the driving signal SET is performed in conjunction with the variation range Rb, as described later.

Operation waveforms of FIG. 15 are different from those of FIG. 14 in that the low level of the driving signal SET is controlled to be a potential VSS+δV that is offset upward from the ground potential VSS of FIG. 14 by δVt, and that the high level of the driving signal SET is controlled to be a potential VDD+δV that is offset upward from the power supply voltage VDD of FIG. 14 by δVt. Accordingly, when the signal voltage is read out to the data line /DL during the respective amplification periods T3 of the left and right sides of FIG. 15, a relative position relation of the variation range Rb relative to the potential of the driving signal SET is the same condition as in FIG. 14. As a result, the shifting of the variation range Rb of the threshold voltage Vt21 due to the temperature and process fluctuations can be compensated.

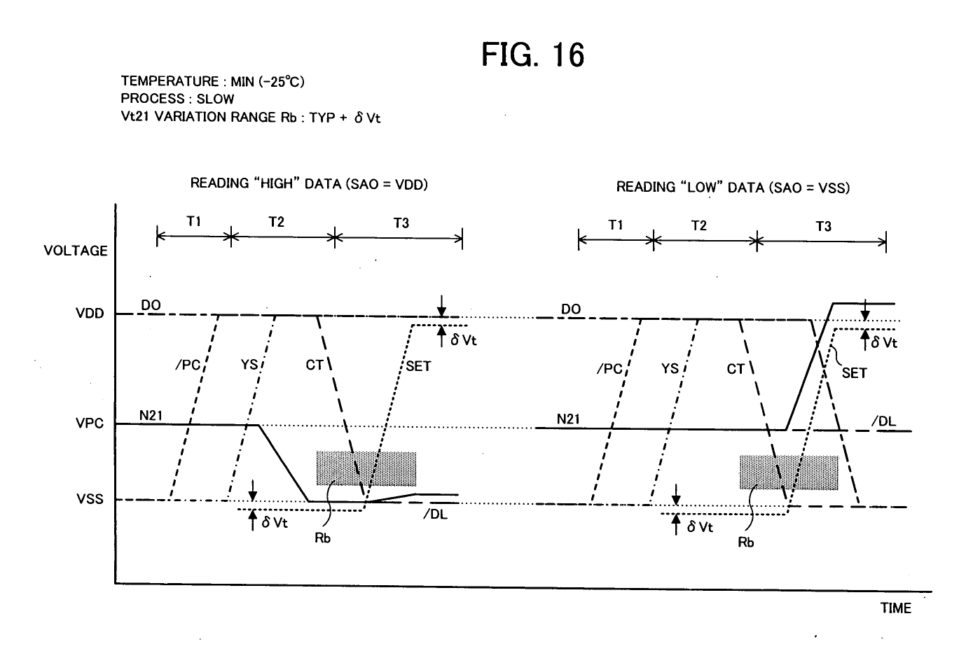

Next FIG. 16 shows an operation waveform diagram in a case where the operating temperature T is minimum (MIN: −25 degrees Celsius, for example), the manufacturing process is slow speed (SLOW), and the variation range Rb of the threshold voltage Vt21 is shifted upward from the typical. Specifically, the variation range Rb of FIG. 16 is shifted to a condition (TYP+δVt) higher than the condition of FIG. 14 (TYP) by δVt. For such a condition, in the third embodiment, the offset control of the potential of the driving signal SET is performed in conjunction with the variation range Rb similarly as in FIG. 15.

Operation waveforms of FIG. 16 are different from those of FIG. 14 in that the low level of the driving signal SET is controlled to be a potential VSS−δV that is offset downward from the ground potential VSS of FIG. 14 by δVt, and that high level of the driving signal SET is controlled to be a potential VDD−δV that is offset downward from the power supply voltage VDD of FIG. 14 by δVt. Accordingly, when the signal voltage is read out to the data line /DL during the respective amplification periods T3 of the left and right sides of FIG. 16, a relative position relation of the variation range Rb relative to the potential of the driving signal SET is the same condition as in FIGS. 14 and 15. As a result, the shifting of the variation range Rb of the threshold voltage Vt21 due to the temperature and process fluctuations can be compensated.

Circuit configurations of the threshold voltage monitor circuit 30 of FIG. 6, the δVt generation circuit 31 of FIG. 7, the VSH generation circuit 32 and the VSL generation circuit 33 of FIG. 8, and the driving signal generation circuit 34 of FIG. 9 can be applied to the third embodiment in the same manner as in the first embodiment. However, the replica FET Q1R in the threshold voltage monitor circuit 30 of FIG. 6 is assumed to be replaced with a replica FET Q21R having the same characteristics as the FET Q21 of FIG. 13, and the threshold voltage Vt1R in other figures is assumed to be replaced with a threshold voltage Vt21R. If the configurations of the first and third embodiments are applied to a single semiconductor device 100, respective replica transistors and respective circuits associated with the replica transistors including the VSH generation circuit 32, the VSL generation circuit 33 and the driving signal generation circuit 34 may be correspondingly provided for both the embodiments. Or either one of the replica transistors and the circuit associated therewith can be used.

AS described above, in the data amplifier DA of the third embodiment, when the variation range Rb of the threshold voltage Vt21 of the FET Q21 as the gated diode whose gate electrode is connected to the node N21 fluctuates by δVt, control is performed so that the low level (VSS) and the high level (VDD) of the driving voltage VSET for the FET Q21 are offset by −δVt, respectively. Thus, the voltage relation between the FETs Q21 and Q23 relative to the signal voltage of the data line /DL is kept the same, the fluctuation of the threshold voltage Vt21 due to the process and temperature fluctuations is compensated, and it is possible to prevent a decrease in sensing margin in the data amplifier DA. Additionally, the offset control may be performed only for the low level of the driving signal SET, similarly as in the first embodiment. The above described effects are common in a later described fourth embodiment.

### Fourth Embodiment

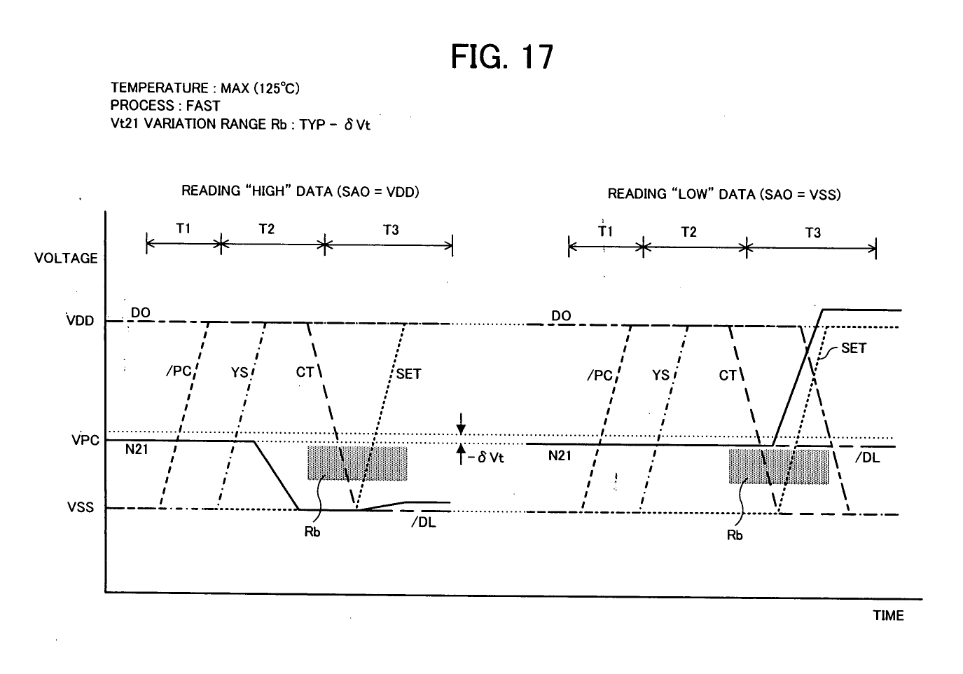

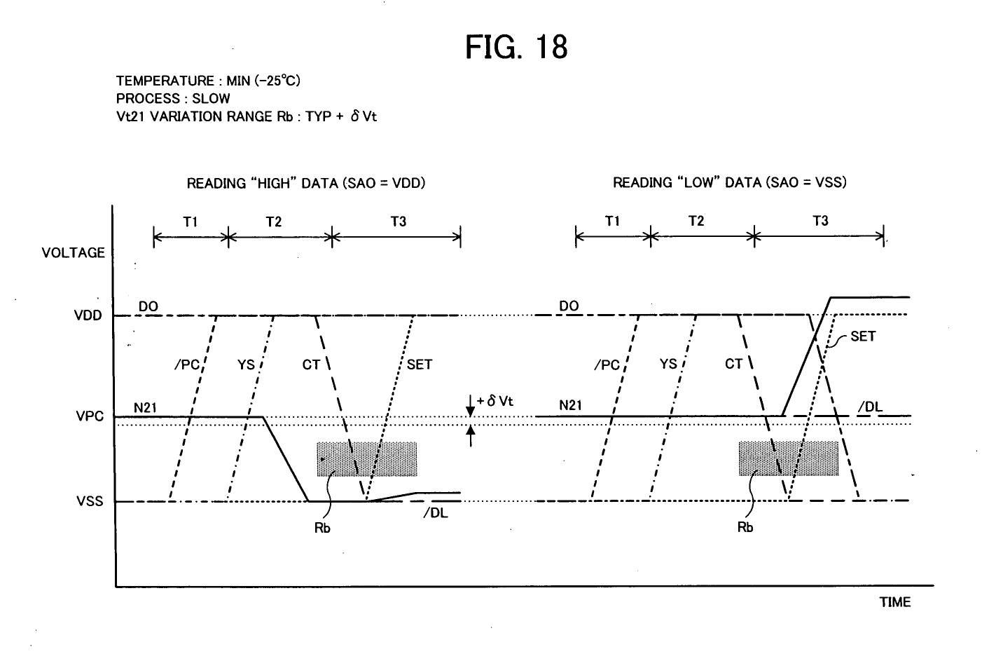

Next, a DRAM of a fourth embodiment to which the present invention is applied will be described. Although voltage control conditions in the fourth embodiment are different from those in the third embodiment, the entire configuration of the DRAM of FIG. 1 and the circuit configuration of the data amplifier DA and its peripheral portion of FIG. 13 are the same as in the third embodiment and thus description thereof will be omitted. In the following, an operation in which data read out to the data line /DA from the sense amplifier SA in the data amplifier DA of the fourth embodiment will be described with reference to FIGS. 17 and 18.

Next, FIG. 17 shows an operation waveform diagram in a case where the operating temperature T is maximum (MAX: 125 degrees Celsius, for example), the manufacturing process is fast speed (FAST), and the variation range Rb of the threshold voltage Vt21 is shifted downward by δVt from the typical, similarly as in FIG. 15. Although the offset control is performed for both low and high levels of the driving signal SET in the third embodiment (FIG. 15), a feature of the fourth embodiment is that the precharge voltage VPC is offset to a value lower by δVt, instead of offsetting the driving signal SET. As a result, it is possible to compensate the shifting of the variation range Rb of the threshold voltage Vt21 due to the temperature and process fluctuations. In addition, the lower limit of the variation range Rb of the threshold voltage Vt21 is desired to remain higher than the ground potential VSS even in the condition of TYP−δVt.

FIG. 18 shows an operation waveform diagram in a case where the operating temperature T is minimum (MIN: −25 degrees Celsius, for example), the manufacturing process is slow speed (SLOW), and the variation range Rb of the threshold voltage Vt21 is shifted upward from the typical, similarly as in FIG. 16. The offset control is performed so as to offset the precharge voltage VPC to a value higher by δVt, similarly as in FIG. 17, instead of offsetting the driving signal SET to a value higher by δVt (FIG. 16). As a result, it is possible to compensate the shifting of the variation range Rb of the threshold voltage Vt21 due to the temperature and process fluctuations.

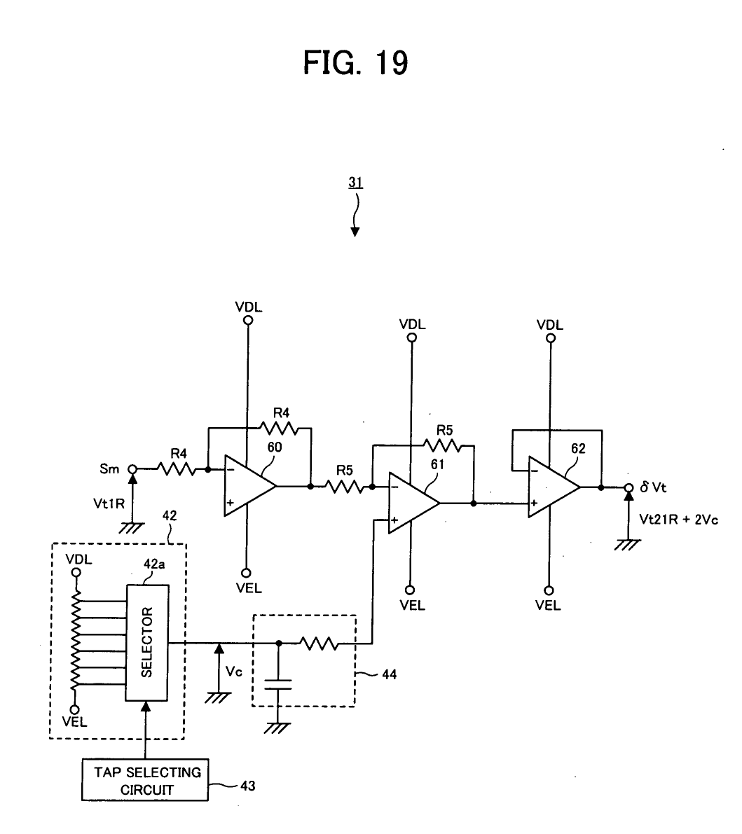

FIG. 19 shows a circuit configuration example of the δVt generation circuit 31 of the fourth embodiment. The δVt generation circuit 31 of FIG. 19 has the approximately same configuration as the δVt generation circuit 31 in FIG. 12 of the second embodiment. In FIG. 19, it is different from FIG. 12 in that two identical resistors R4 are added to the operational amplifier 60 and the gain thereof is set to 1.

In the fourth embodiment, the circuit configuration being the same as that in FIG. 8 of the first embodiment is applied to a VPC generation circuit. However, the reference voltage Vref in the VPC generation circuit is set to, for example, Vref=0.4V, differently from the first embodiment. Thus, when δVt=±0.1V is satisfied, VPC=0.4±0.1V can be obtained in the VPC generation circuit.

The fourth embodiment can be also applied to a precharge circuit of the bit line BL. Specifically, the ground potential VSS supplied to the source electrode of the FET Q5 as the precharge circuit of the bit line BL is replaced with a control voltage VBLC and the circuit configuration being the same as that in FIG. 8 of the first embodiment is applied to a VBLC generation circuit. However, the reference voltage Vref in the VPC generation circuit is set to, for example, Vref=0.0V, differently from the first embodiment. Thus, when δVt=±0.1V is satisfied in the VPC generation circuit, VPC=0.0±0.1V can be obtained in the VPC generation circuit. In the fourth embodiment, it is possible to employ at least one of the VPC generation circuit and the VBLC generation circuit or both of them.

### [Data Processing System]

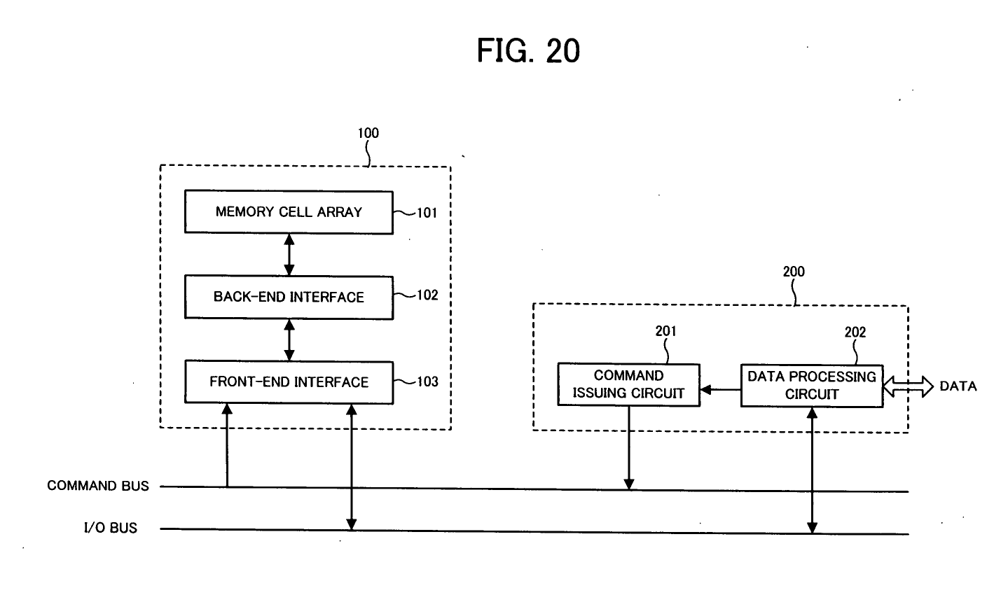

Next, a case in which the present invention is applied to a data processing system comprising a semiconductor device 100 will be described. FIG. 20 shows a configuration example of the data processing system comprising a semiconductor device 100 having the configuration described in the embodiments and a controller 200 controlling operations of the semiconductor device 100.

The semiconductor device 100 is provided with a memory cell array 101, a back-end interface 102 and a front-end interface 103. A large number of memory cells MC of the embodiments are arranged in the memory cell array 101. The back-end interface 102 includes the sense amplifier array 12a, the data amplifier array 12b, and peripheral circuits thereof of the embodiments. The front-end interface 103 has a function to communicate with the controller 200 through a command bus and an I/O bus. Although FIG. 20 shows one semiconductor device 100, a plurality of semiconductor devices 100 can be provided in the system.

The controller 200 is provided with a command issuing circuit 201 and a data processing circuit 202, and controls operations of the system as a whole and the operation of the semiconductor device 100. The controller 200 is connected with the command bus and the I/O bus, and additionally has an interface for external connection. The command issuing circuit 201 sends commands to the semiconductor device 100 through the command bus. The data processing circuit 202 sends and receives data to and from the semiconductor device 100 through the I/O bus and performs processes required for the controlling. In addition, the semiconductor device of the embodiments may be included in the controller 200 in FIG. 20.

The data processing system of FIG. 20 is, for example, a system implemented in electronics devices such as personal computers, communication electronics devices, mobile electronics devices and other industrial/consumer electronics devices.

In the foregoing, the preferred embodiments of the present invention have been described. However the present invention is not limited to the above embodiments and can variously be modified without departing the essentials of the present invention, and the present invention obviously covers the various modifications. That is, the present invention covers the various modifications which those skilled in the art can carry out in accordance with all disclosures including claims and technical ideas. For example, the present invention can be applied to a configuration including a transmission route of a data signal in a memory, a data processor and the like. Further, various circuit configurations can be employed for the sense amplifier SA, the data amplifier DA and the like without being limited to the configurations described in the embodiments. Furthermore circuits that generate various voltages are not limited to the configurations described in the embodiments.

The present invention is not limited to the DRAM, and can be applied to various semiconductor devices having transmission lines and amplifiers connected thereto, such as CPU (Central Processing Unit), MCU (Micro Control Unit), DSP (Digital Signal Processor), ASIC (Application Specific Integrated Circuit), ASSP (Application Specific Standard Product) and the like. Also the present invention can be applied to a memory unit included in the devices such as CPU.

Further, various materials and structures can be adapted to form a field-effect transistor (FET) used as the transistors of the embodiments. For example, various types such as MIS (Metal-Insulator Semiconductor), TFT (Thin Film Transistor), and the like can be used as the FET for the transistors, in addition to MOS (Metal Oxide Semiconductor) transistor, and transistors other than FETs can be used for other transistors. Further, an N-channel type transistor (NMOS transistors) is a typical example of a first conductive type transistor, and a P-channel type transistor (PMOS transistor) is a typical example of a second conductive type transistor. Although a voltage relation is based on the ground potential VSS in the configuration of the embodiments, the present invention can be applied to a reverse voltage relation based on the power supply voltage VDD. In this case, the NMOS type FETs included in the configuration of the embodiments may be replaced with PMOS type FETs.

1. A semiconductor device comprising:
a first circuit outputting a signal to a first signal line;
a first FET in which a gate electrode is connected to a first node and a driving signal is applied to either or both of source and drain electrodes, the first FET having a gate capacitance controlled in response to a voltage difference between potentials of the first node and the driving signal;
a second FET controlling an electrical connection between the first signal line and the first node in response to a first control signal applied to a gate electrode;
a third FET sensing a signal voltage of the first node and outputting an amplified signal to a second node, the third FET having a gate electrode connected to the first node;
a second circuit setting a third potential to the first signal line; and
a voltage control circuit transitioning the driving signal from a first potential to a second potential in a state where the second FET is controlled to be non-conductive after the signal of the first circuit is transmitted to the first node via the first line and the second FET being in a conductive state,
wherein the voltage control circuit performs an offset control for at least one of the first and third potentials so as to compensate a variation of a threshold voltage of the first FET.

2. The semiconductor device according to claim 1, wherein the voltage control circuit further performs an offset control for the second potential with a same offset amount as the first potential so as to compensate the variation of the threshold voltage of the first FET.

3. The semiconductor device according to claim 2, wherein offset amounts of the first and second potentials have a same magnitude as that of the variation of the threshold voltage of the first FET, and the first and second potentials are offset in a direction reverse to a direction of the variation of the threshold voltage of the first FET,

4. The semiconductor device according to claim 3, wherein the voltage control circuit includes a replica element having same characteristics as the first FET, monitors a threshold voltage of the replica element, and controls one of the magnitudes of the offset amounts of the first and second potentials and a magnitude of an offset amount of the third potential based on a monitored threshold voltage of the replica element and a correction amount.

5. The semiconductor device according to claim 1,
wherein the first circuit includes a bit line as the first signal line and a plurality of memory cells selectively connected to the bit line,
the second circuit includes a write circuit converting an output data of a sense amplifier including the third FET into a predetermined voltage so as to restore the data to a selected one of the memory cells by driving the word line based on converted data, and
the voltage control circuit performs an offset control for the voltage amplitude of the write circuit instead of the offset control for the first potential so as to compensate the variation of the threshold voltage of the first FET.

6. The semiconductor device according to claim 5, wherein the write circuit includes a level shifter converting a level of the predetermined voltage into a level driving the bit line.

7. The semiconductor device according to claim 5, wherein a plate voltage is applied to one end of a capacitor of each of the memory cells, the capacitor storing data as electric charge, and the voltage control circuit further performs an offset control for the plate voltage so as to compensate the variation of the threshold voltage of the first FET.

8. The semiconductor device according to claim 1, wherein the second circuit includes a first precharge circuit precharging the first signal line to a first precharge voltage as the third potential, and the voltage control circuit performs an offset control for the first precharge voltage instead of the offset control for the first potential so as to compensate the variation of the threshold voltage of the first FET.

9. The semiconductor device according to claim 8, wherein the first precharge voltage is lower than a precharge voltage for precharging the second node.

10. The semiconductor device according to claim 1 further comprising a fourth FET connected in series with the third FET between the second node and a third node, the fourth FET having a gate electrode to which the driving signal is applied.

11. The semiconductor device according to claim 10 further comprising a second precharge circuit precharging the second node to a second first precharge voltage in response to a second precharge signal.

12. The semiconductor device according to claim 10 further comprising a latch circuit latching an output signal transmitted via the second node.

13. The semiconductor device according to claim 1, wherein the first circuit includes a bit line as the first signal line and a plurality of memory cells selectively connected to the bit line.

14. The semiconductor device according to claim 1, wherein the first circuit includes a sense amplifier outputting amplified data to a data line as the first signal line, and the third FET is a data amplifier further amplifying the data amplified by the sense amplifier.

15. The semiconductor device according to claim 14 wherein the first circuit comprises:
a third circuit outputting a signal to a second signal line;
a fifth FET in which a gate electrode is connected to a fourth node and a second driving signal is applied to either or both of source and drain electrodes, the fifth FET having a gate capacitance controlled in response to a voltage difference between potentials of the fourth node and the second driving signal;
a sixth FET controlling an electrical connection between the second signal line and the fourth node in response to a second control signal applied to a gate electrode;
a seventh FET sensing a signal voltage of the fourth node and outputs an amplified second signal to an output node, the seventh FET having a gate electrode connected to the fourth node;
a fourth circuit setting a sixth potential to the second signal line; and
a second voltage control circuit transitioning the second driving signal from a fourth potential to a fifth potential in a state where the second FET is controlled to be non-conductive after the signal of the third circuit is transmitted to the fourth node via the second line and the sixth FET being in a conductive state,
wherein the voltage control circuit performs an offset control for at least one of the fourth and sixth potentials so as to compensate a variation of a threshold voltage of the fifth FET.

16. The semiconductor device according to claim 8, wherein the first circuit includes a sense amplifier outputting amplified data to a data line as the first signal line, and the third FET is a data amplifier further amplifying the data amplified by the sense amplifier.

17. The semiconductor device according to claim 16 wherein the first circuit comprises:
a third circuit outputting a signal to a second signal line;
a fifth FET in which a gate electrode is connected to a fourth node and a second driving signal is applied to either or both of source and drain electrodes, the fifth FET having a gate capacitance controlled in response to a voltage difference between potentials of the fourth node and the second driving signal;
a sixth FET controlling an electrical connection between the second signal line and the fourth node in response to a second control signal applied to a gate electrode;
a seventh FET sensing a signal voltage of the fourth node and outputs an amplified second signal to an output node, the seventh FET having a gate electrode connected to the fourth node;
a fourth circuit setting a sixth potential to the second signal line; and
a second voltage control circuit transitioning the second driving signal from a fourth potential to a fifth potential in a state where the second FET is controlled to be non-conductive after the signal of the third circuit is transmitted to the fourth node via the second line and the sixth FET being in a conductive state,
wherein the voltage control circuit performs an offset control for at least one of the fourth and sixth potentials so as to compensate a variation of a threshold voltage of the fifth FET.

18. The semiconductor device according to claim 1 further comprising:
a third circuit transmitting a signal sensed and amplified by the third FET to a second signal line;
a fifth FET in which a gate electrode is connected to a fourth node and a second driving signal is applied to either or both of source and drain electrodes, the fifth FET having a gate capacitance controlled in response to a voltage difference between potentials of the fourth node and the second driving signal;
a sixth FET controlling an electrical connection between the second signal line and the fourth node in response to a second control signal applied to a gate electrode;
a seventh FET sensing a signal voltage of the fourth node and outputs an amplified second signal to an output node, the seventh FET having a gate electrode connected to the fourth node;
a fourth circuit setting a sixth potential to the second signal line; and
a second voltage control circuit transitioning the second driving signal from a fourth potential to a fifth potential in a state where the second FET is controlled to be non-conductive after the signal of the third circuit is transmitted to the fourth node via the second line and the sixth FET being in a conductive state,
wherein the voltage control circuit performs an offset control for at least one of the fourth and sixth potentials so as to compensate a variation of a threshold voltage of the fifth FET.

19. The semiconductor device according to claim 18, wherein the second voltage control circuit further performs an offset control for the fifth potential with a same offset amount as the fourth potential so as to compensate the variation of the threshold voltage of the fifth FET.

20. The semiconductor device according to claim 19, wherein offset amounts of the fourth and fifth potentials have a same magnitude as that of the variation of the threshold voltage of the fifth FET, and the fourth and fifth potentials are offset in a direction reverse to a direction of the variation of the threshold voltage of the fifth FET,

21. The semiconductor device according to claim 20, wherein the voltage control circuit includes a second replica element having same characteristics as the fifth FET, monitors a threshold voltage of the second replica element, and controls one of the magnitudes of the offset amounts of the fourth and fifth potentials and a magnitude of an offset amount of the sixth potential based on a monitored threshold voltage of the second replica element and a correction amount.

22. A data processing system comprising:
a semiconductor device; and
a controller connected to the semiconductor device through a bus, the controller processing data stored in the semiconductor device and controlling operations of the system as a whole and an operation of the semiconductor device, wherein
the semiconductor device comprising:
a first circuit outputting a signal to a first signal line;
a first FET in which a gate electrode is connected to a first node and a driving signal is applied to either or both of source and drain electrodes, the first FET having a gate capacitance controlled in response to a voltage difference between potentials of the first node and the driving signal;
a second FET controlling an electrical connection between the first signal line and the first node in response to a first control signal applied to a gate electrode;
a third FET sensing a signal voltage of the first node and outputs an amplified signal to a second node, the third FET having a gate electrode connected to the first node;
a second circuit setting a third potential to the first signal line; and
a voltage control circuit transitioning the driving signal from a first potential to a second potential in a state where the second FET is controlled to be non-conductive after the signal of the first circuit is transmitted to the first node via the first line and the second FET being in a conductive state,
wherein the voltage control circuit performs an offset control for at least one of the first and third potentials so as to compensate a variation of a threshold voltage of the first FET.
